(19) United States
(12) Patent Application Publication
(10) Pub. No.: US 2024/0372628 A1
(43) Pub. Date: Nov. 7, 2024

(54) OPTICAL SIGNAL GENERATION DEVICE FOR QUANTUM KEY DISTRIBUTION

(71) Applicant: THALES, MEUDON (FR)

(72) Inventors: Jean-Didier GAYRARD, CUGNAUX (FR); Mathieu BERTRAND, TOULOUSE (FR)

(21) Appl. No.: 18/654,540

(22) Filed: May 3, 2024

(30) Foreign Application Priority Data
May 4, 2023 (FR) 2304460

(51) Int. Cl. H04B 10/70; H04B 10/118

(52) U.S. Cl. CPC H04B 10/70; H04B 10/118

(57) ABSTRACT

An optical signal generation device for quantum key exchange, includes a photon source generating at least one pulse stream, an ADC transducer converting the photons of a pulse stream into a random binary string, a quantum state modulator putting the photons of the pulses into a number and quantum state defined by a control word in order to generate the optical signal from one of the pulse streams, digital computing means: generating at least one random sequence having a given probability distribution and rate, based on the random binary string, generating the control word in accordance with the key exchange protocol based on said at least one random sequence. A payload for a satellite, comprising such an optical signal generation device is also provided.

### CROSS-REFERENCE TO RELATED APPLICATION

This application claims priority to foreign French patent application No. FR 2304460, filed on May 4, 2023, the disclosure of which is incorporated by reference in its entirety.

### FIELD OF THE INVENTION

The invention lies in the technical field of devices enabling quantum key distribution (QKD) or exchange, and more particularly when the key exchange is implemented using a discrete-variable (DV) Prepare & Measure protocol.

The invention relates to a high-performance and compact optical signal transmission device that exhibits high resistance to the risks of electromagnetic radiation measurement attacks.

### BACKGROUND

FIG. 1 schematically shows the operation of a quantum optical link secret key exchange/distribution (QKD).

This exchange/distribution involves:
a transmitter 101 (generally called Alice) configured to transmit a string of qubits on an optical channel 102. In discrete-variable Prepare and Measure protocols, a qubit corresponds to a photon the quantum state of which codes the information 0 or 1 on multiple possible randomly chosen bases (this corresponding to the Prepare step). The state of the photon may be for example its polarization, its phase, its time of arrival, etc.;
a qubit receiver/detector 103 (generally called Bob), which detects photons in a randomly chosen base, and measures the state thereof, and therefore the value (0 or 1) (this corresponding to the Measure step).

To establish a key, the transmitter 101 transmits a random string of qubits (string of 0s and 1s) in randomly chosen bases. The receiver 103 measures the qubits of this string on its own bases and reconstructs an incomplete and fragmentary string of bits, following signal degradations related to transmission on the optical link 102 (photons lost on the path, parasitic photons, measurement errors, etc.). What is known as a reconciliation process, carried out on a reconciliation channel 104, makes it possible to generate a secret key known only to the transmitter 101 (Alice) and the receiver 103 (Bob) based on the two random strings: the random string transmitted by Alice and the string received and reconstructed by Bob.

In discrete-variable Prepare and Measure protocols, such as for example the BB84 protocol, the transmitter 101 (Alice) transmits a random string of qubits encoded on multiple possible bases and two possible values (0 and 1). Ideally, the qubits consist of single photons. In embodiments in which the optical source is an attenuated laser, and not a single-photon source, said source generates coherent states that may contain a finite number of photons per pulse with a Poisson distribution. Decoys may be introduced in order to prevent attacks by a hostile third party (called Eve) based on the measurement of additional photons in the case of multi-photon pulses. Reference is then made to the decoy-state BB84 protocol.

FIG. 2 schematically shows the architecture of a qubit transmitter 200 for a discrete-variable Prepare and Measure protocol, such as for example the BB84 protocol. It comprises:
a clock 201,
an equipment configured to generate a random 202,
an equipment configured to carry out a protocol controller function 203, and
a source equipment of “modulated” photons, or photon emitter 204.

The protocol controller 203 of the qubit transmitter 200 is functionally connected to the reconciliation channel by a device that is denoted reconciliation interface (I/F) 205 for the example. The functions of controlling and managing the reconciliation channel and of controlling and running the reconciliation process are divided between the two devices in the example: the protocol controller 203 of the qubit transmitter and the reconciliation interface 205.

The clock 201 clocks the device and defines the transmission rate of the random string of qubits per pulse train.

This random string is provided by a random number generator 202, and more advantageously by a quantum random number generator (QRNG). A QRNG is a generator that uses a quantum phenomenon to generate randomness. It guarantees excellent entropy for the generated random string. Such a generator is based on a microscopic physical phenomenon that generates a statistically random noise signal (for example shot noise of a photodiode). A random number generator typically consists of:
a transducer for converting the physical phenomenon into a random electrical signal, optionally, an amplifier for amplifying random fluctuations to a measurable level, and
an analogue-to-digital converter (ADC) for converting the signal into a number (binary string of 0s and 1s).

The protocol controller 203 is a digital device (for example a computer, an FPGA (field-programmable gate array), an ASIC (application-specific integrated circuit) or a DSP (digital signal processor)) that drives the photon source in accordance with the chosen protocol. Based on the string of random numbers provided by the QRNG 202, the protocol controller 203 creates a string of instructions or control words intended for the photon emitter 204.

FIG. 3 illustrates the construction of an optical signal used for a quantum key exchange. For example, in the case of a polarization-encoded decoy-state BB84 protocol, the optical signal consists of a succession of temporal pulses 304, these pulses being either qubit pulses or decoy pulses.

With reference to FIG. 3, upon each temporal pulse 304 of the pulse train generated by the clock, the photon emitter or photon source 204, depending on the instructions or control words provided by the protocol controller, emits:
either a temporal pulse containing an average number of photons equal to a predefined value of the protocol and the polarization state of which defines the binary value. This pulse is defined as a qubit. For the BB84 or decoy-state BB84 protocol, the photon of a qubit has four possible polarization states 301: vertical (|), horizontal (-), diagonal (/), and anti-diagonal (\). The value of the polarization state is defined by the control word corresponding to the pulse;
or a pulse containing an average number of photons (or intensity) defined by the corresponding control word. This pulse is defined as a decoy 302. The polarization state of the photons of the decoy pulse adopts one of the four possible polarization states of the photons of the qubit pulses according to the control word.

The number of bits required to code the instruction or control word of the protocol controller 203 for the photon source 204 is at least 4 bits per pulse. For example, 1 bit or more to define the type of pulse (qubit or decoy), 1 bit to define the value of the qubit (0 or 1), 1 bit or more to define the encoding base (rectilinear or diagonal polarization, phase, etc.), 1 bit or more to define the amplitude (or intensity) of the decoy pulse (number of photons per pulse), etc. These instructions intended for the photon emitter 204 are developed and encoded by the protocol controller 203 based on the random string from the random number generator 202 and in accordance with the chosen Prepare and Measure protocol.

Other quantum key exchange protocols are known, such as for example the B92 protocol, which is a simplified version of the BB84 protocol using two polarization states (the horizontal polarization state (-) of the rectilinear base and +45° (/) of the diagonal base), or the SSP protocol (Six-State Protocol), which is also a modified version of BB84 using six polarization states.

To ensure the security of the generated string of qubits 303 when confronted with an attack, the content of the temporal pulses 304 corresponding to qubits and decoys, their polarization states and the amplitude (or intensity) of the decoys must be completely random, with probability densities defined according to the quantum key exchange protocol that is implemented. The quality of the encryption key that is exchanged depends on the entropy of the random sequence.

In the photon emitter 204, the qubits and decoys (typically their polarization and their amplitude) are encoded using various techniques mostly involving attenuated lasers. This photon “modulator” is driven by the protocol controller 203.

However, the existing solutions based on the architecture shown in FIG. 2 exhibit drawbacks:
the speed (that is to say the operating frequency) of the random number generator 202 has to be at least four times higher than the transmission speed of the string of qubits (corresponding to the frequency of the pulse train). Specifically, the protocol controller 203 has to provide a control word with a length of at least 4 bits to the photon emitter 204. The construction of the string of temporal pulses (qubits, decoys) must be random and result from the sequence of random numbers provided by the generator 202. The current state of the art for quantum random number generators (QRNGs) reports operating frequencies of a few tens to a few hundred megahertz, this constituting a limit to the future increase in the speed of qubit sequence transmitters;
the architecture in FIG. 2 denotes multiple distinct equipments: the QRNG 202, the protocol controller 203 and the photon source 204. This architecture has a negative impact on the acquisition cost, development time, provisioning, integration and testing of the qubit transmitter;
an electrical connection is needed between the QRNG 202 and the protocol controller 203. This link may be easily spied on, by remotely measuring the electromagnetic radiation that it generates, this constituting a security flaw.

### SUMMARY OF THE INVENTION

One aim of the invention is therefore to define a compact and competitive optical signal generation device the architecture of which makes it possible to overcome the abovementioned drawbacks of the prior art. The device according to the invention achieves this by integrating, where applicable in one and the same equipment, the functions of photon generator and quantum state modulator, protocol controller, random generation and extraction, and adaptation to the transmission medium (optical fibre or free space).

To this end, the present invention describes a device for generating an optical signal in the form of a succession of optical pulses a quantum state of which codes binary information for quantum key exchange between a transmitter and a receiver. The device according to the invention comprises, in one and the same equipment:
a photon source configured to generate at least one pulse stream comprising one or more photons,
a device, referred to as ADC transducer, configured to convert the photons of one of the pulse streams generated by the photon source into a random binary string, a quantum state modulator configured to generate the optical signal based on one of the pulse streams generated by the photon source by adjusting the number and quantum state of the one or more photons of the pulses, the number and quantum state of the one or more photons of the pulses being defined by a control word, digital computing means configured to:
   generate at least one random sequence having a given probability distribution and rate, based on the random binary string produced by the ADC transducer,
   generate the control word that is transmitted to the quantum state modulator in accordance with a given key exchange protocol, based on the one or more random sequences.

According to one embodiment of the invention, the optical signal generation device furthermore comprises a device for adapting the optical signal delivered by the quantum state modulator to the transmission medium of the optical signal.

Advantageously, the transmission medium of the optical signal is chosen from among an optical fibre and free space.

Depending on the embodiment of the optical signal generation device according to the invention, the photon source may be:
a pulsed laser configured to generate an optical pulse stream, associated with a power divider configured to generate at least two pulse streams from the pulse stream of the pulsed laser;
a pulsed laser configured to generate two pulse streams,
a single-photon source configured to generate a stream of pulses each comprising a photon, associated with a splitter plate configured to divide the pulse stream into at least two distinct pulse streams, or
a single-photon source configured to generate two streams of single photons.

The ADC transducer is configured to exploit a random quantum phenomenon of the photons of one of the pulse streams generated by the photon source to determine the random binary string.

Depending on the embodiment of the optical signal generation device according to the invention, the random quantum phenomenon exploited by the ADC transducer is chosen from among:
the initial phase of the pulses,
the amplitude of the pulses,
the time of occurrence of the pulses,
the speckle patterns of the pulses.

Advantageously, the one or more random sequences generated by the computing means are obtained by applying one-way mathematical functions to the random binary string produced by the ADC transducer.

According to one embodiment of the optical signal generation device according to the invention, the digital computing means are furthermore configured to implement a reconciliation process on the data transmitted to the receiver.

The invention also relates to a payload for a satellite configured to carry out a quantum key exchange mission with a ground station, the payload comprising:
an optical signal generation device according to one embodiment of the invention,
an optical terminal connected to an output of the optical signal generation device,
an optical modem connected to said optical terminal or a radiofrequency modem connected to a radio antenna,
a mission controller configured to supervise the scheduling of the quantum key exchange operations, and
a polarization synchronization and measurement device configured to ensure synchronization between the optical signal generation device and the ground station,
and to measure distortions experienced by the optical signal between the optical signal generation device and the ground station.

### BRIEF DESCRIPTION OF THE DRAWINGS

The invention will be better understood and other features, details and advantages will become more clearly apparent on reading the following non-limiting description, and by virtue of the appended figures, which are given by way of example, among which:

FIG. 1 schematically shows the operation of a quantum optical link secret key exchange/distribution (QKD).

FIG. 2 schematically shows the architecture of a qubit transmitter for a discrete-variable Prepare and Measure protocol according to the prior art.

FIG. 3 illustrates the construction of an optical signal according to the prior art, used for a quantum key exchange.

FIG. 4 schematically shows the architecture of a type of quantum random number generator, as known from the prior art.

FIG. 5 shows an optical signal generation device according to one embodiment of the invention.

FIG. 6 shows an optical signal generation device according to another embodiment of the invention.

FIG. 7 shows an optical signal generation device according to another embodiment of the invention.

FIG. 8 illustrates the components of a satellite quantum key exchange mission.

FIG. 9 illustrates one example of a payload on board a satellite.

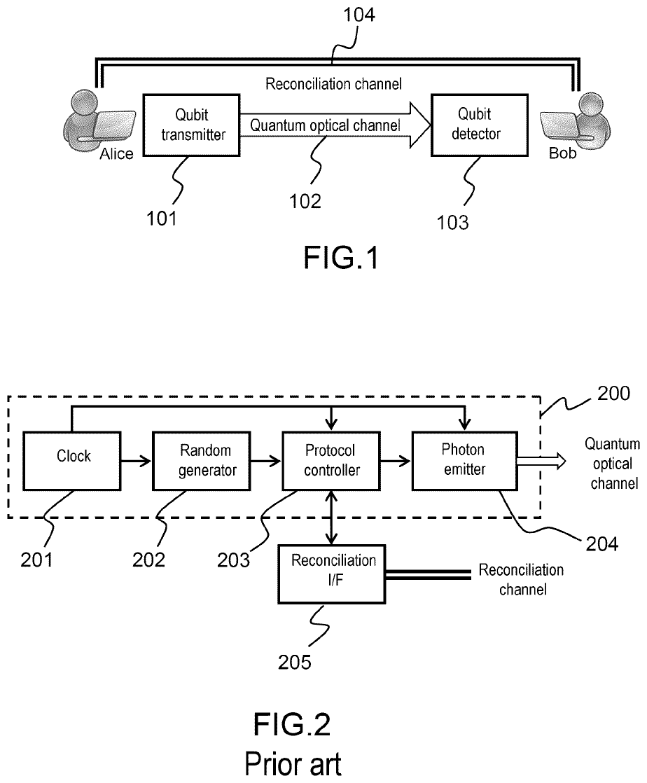

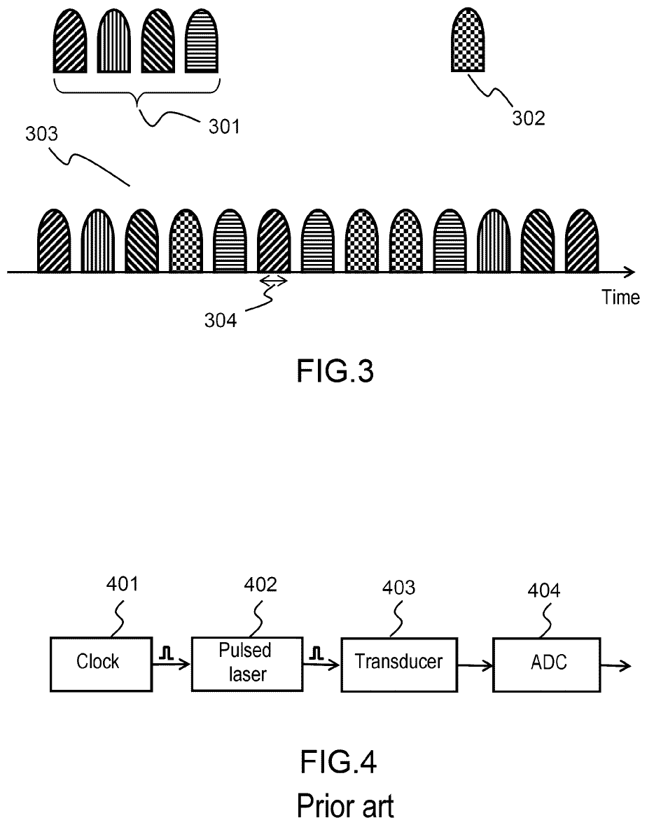

Identical references may be used in different figures to designate identical or comparable elements.

### DETAILED DESCRIPTION

Those skilled in the art are familiar with quantum random number generators (QRNG) using the physical properties of random quantum phenomena of pulsed lasers. FIG. 4 shows such a quantum random number generator. It comprises a pulsed laser 402 configured to generate a pulse stream clocked by a clock 401. The pulse stream is converted into a random binary string by a transducer 403 and an analogue-to-digital converter (ADC) 404 using the random quantum properties of the pulses, for example the initial phase of the pulses, their amplitude or intensity, their time of occurrence (position in the pulse), speckle patterns, etc. The transducer 403 converts the chosen random quantum physical property into an electrical signal, amplifies it and formats it. The analogue-to-digital converter (ADC) 404 converts the electrical signal generated and amplified by the transducer into a digital value (a binary word of 8 bits, for example). Due to the highly random nature of the physical properties of quantum phenomena, the generated sequence of digital values is random, with very good entropy.

The idea of the invention is to combine the functions of quantum random number generator and photon emitter, and advantageously to group these functions and the functionality of protocol controller into a single autonomous equipment. In addition, a random extraction function is added thereto that makes it possible to:
increase qubit throughput,
increase the entropy of the random string of qubits, and
provide the protocol controller with random strings of bits with probability densities adapted to the protocol.

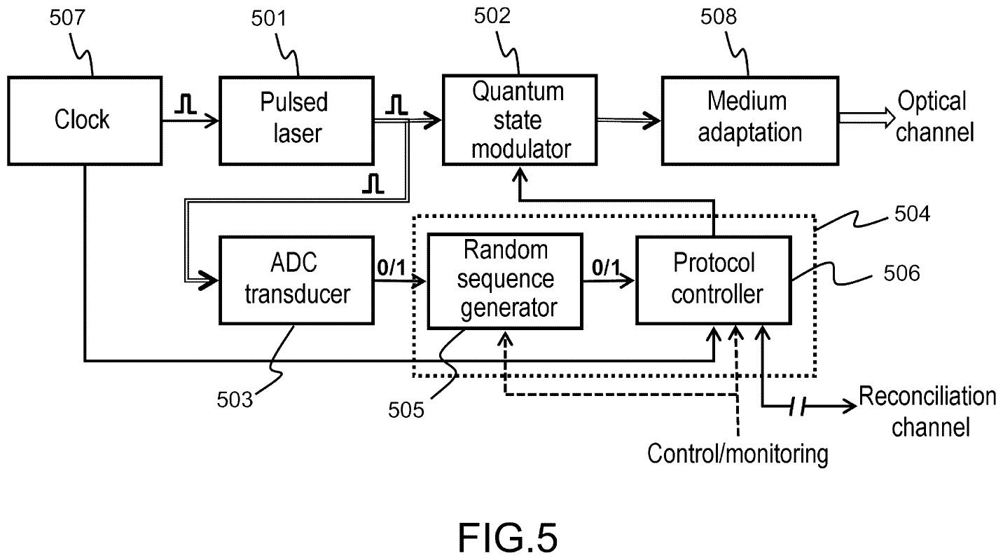

FIG. 5 shows an optical signal generation device according to one embodiment of the invention. It comprises a photon source 501, here a pulsed laser emitting a series of pulses. This series of pulses is transmitted to a quantum state modulator 502, on the one hand, and to an ADC transducer 503, on the other hand. The pulse stream may be divided for example using an optical splitter, such as a semi-reflective mirror, which will extract and redirect a portion of the main optical stream.

The ADC transducer 503 consists of a transducer that converts a quantum property of the optical pulse into an electrical signal, and an analogue-to-digital converter ADC that converts the electrical signal into a digital value (binary word). The ADC transducer 503 is configured to convert each optical pulse of one of the pulse streams generated by said photon source into a random binary word, exploiting the quantum properties of the pulses to do so, in a manner comparable to what is carried out in quantum random number generators according to the prior art, such as the one shown in FIG. 4. The succession of random binary words constitutes a random binary string that is supplied to a random sequence generation function 505.

The optical signal generation device according to the invention also comprises digital computing means 504, such as for example an ASIC, an FPGA, a DSP, or a microprocessor, configured to carry out the random sequence generation function 505, and a protocol controller function 506.

The random sequence generation function 505 takes the random binary string delivered by the ADC transducer 503 at input, and uses it to generate one or more random sequences having a probability distribution and rate that are adapted to the key exchange protocol that is implemented. Specifically, the random binary string delivered by the ADC transducer 503 has a rate proportional to the rate of the pulses from the laser 501, and which is potentially insufficient to generate the control words used by the quantum state modulator 502 to define the content and characteristics of the optical pulses (qubit, decoy). This rate has to be increased, and the probability distribution has to be adapted to the chosen transmission protocol. For example, in the case of a decoy-state BB84 protocol implemented by 4-bit control words as described above, one possible implementation is to generate:
a sequence at the rate of the pulses, having a first probability density to define whether the pulse is a signal pulse or a decoy pulse,
a sequence at the rate of the pulses, having a second probability density to define the amplitude of the decoy pulses,
a sequence, at the rate of the pulses, having a third probability density for the qubit encoding base,
a sequence, at the rate of the pulses, having a probability density equal to the third probability density for the value of the qubits, etc.

When random strings have equal probability densities, such as those for the encoding base and the value of the qubits, they may be grouped within one and the same random sequence the rate of which is increased compared to the bit rate of the random binary string used at input.

The generation, based on a first random sequence (mother sequence), of a new random sequence (daughter sequence) the properties (rate and probability density) of which are adjusted with respect to a given need, is an operation known to those skilled in the art, and may be carried out by applying mathematical functions, such as for example a one-way function such as the hash function, to the daughter random sequences. These mathematical functions ensure that it is impossible for an observer (Eve) to recover the other random sequences based on one of the (daughter) random sequences that may have been reconstructed. Other mathematical functions, such as mixing (random permutation) of the sequences, are also possible.

The choice of the number of sequences, their rates and the respective probability densities depends on the quantum key exchange protocol that is implemented.

The digital computing means 504 are configured to carry out a network controller function 506, which consists in:
using the one or more random sequences generated by the generator 505 to form, for each pulse, control instructions for the quantum state modulator 502. These instructions therefore define the qubits and decoys that will be transmitted over the optical link in accordance with the QKD protocol that is implemented,
optionally, carrying out exchanges with the receiver via a radiofrequency (RF) or optical reconciliation channel in order to determine a secret key,
when the optical signal generation device is compatible with multiple QKD protocols, adjusting the properties of the random sequence generation function 505 according to the chosen protocol.

The quantum state modulator 502 has two actions on the optical pulses delivered by the pulsed laser 501: it attenuates the intensity of the optical pulse so as to fix the average number of photons per pulse, and it fixes the quantum state of the photons of the pulse. The intensity of the pulse (average number of photons) and the quantum state of the photons are defined for each pulse by a control word that is provided by the protocol controller 506. The quantum state modulator 502 modifies the stream of optical pulses generated by the pulsed laser 501 into a succession of qubits and decoys, by fixing the average number and quantum state of the photons of each optical pulse in accordance with the control word given by digital computing means 504. To do this, it encodes the qubits and decoys by adjusting the amplitude of the pulses (average number of photons per pulse) and the state (for example the polarization) of the photons in accordance with the control word transmitted by the protocol controller 506.

Advantageously, the optical signal generation device according to the invention comprises a clock 507 that is used to clock the emissions from the photon source 501 and to synchronize the protocol controller function 506 with the pulse stream.

Advantageously again, the optical signal generation device according to the invention comprises a device 508 for adapting to the transmission medium. The transmission medium (optical channel) may be free space or an optical fibre. The device 508 for adapting to the medium controls for example the polarization axes of the transmitted optical signal depending on the medium, by defining the polarization axis in absolute terms, which polarization axis may differ depending on the medium. This adaptation is carried out in collaboration with the receiver to measure distortions in quantum states (for example polarization) that are caused by propagation on the transmission medium. This distortion measurement may be carried out for example via the optical channel before the qubits are transmitted in the case of transmission over fibre or via an optical reference channel dedicated to this function in the case of free-space transmission.

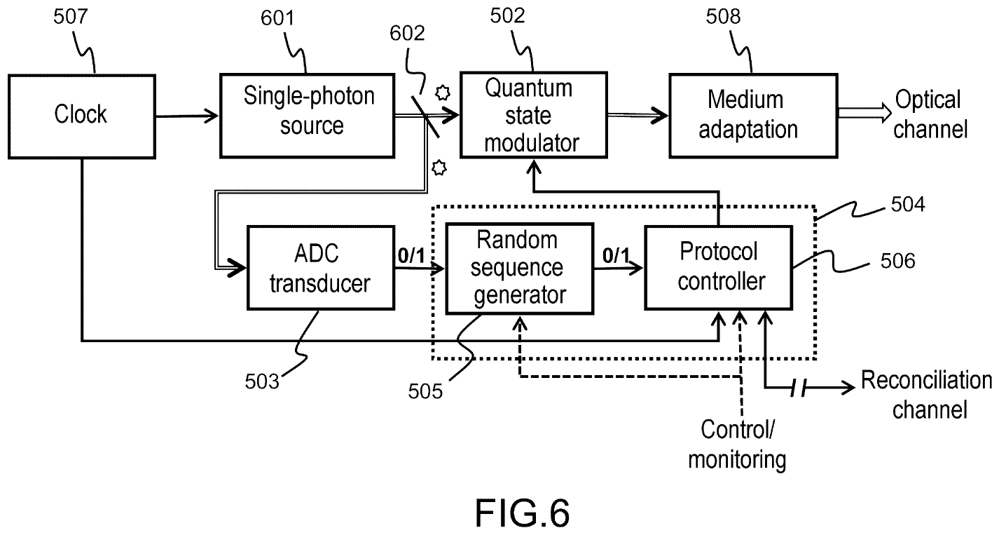

FIG. 6 shows an optical signal generation device according to another embodiment of the invention. In this embodiment, the photon source 601 is a single-photon source known to those skilled in the art. The device then comprises a photon separation device 601, such as for example a splitter plate. Some of the photons are extracted so as to be supplied to the quantum state modulator 502, and the others are transmitted to the ADC transducer 503. With the exception of the photon source, the operation of the device is identical to that described in FIG. 5.

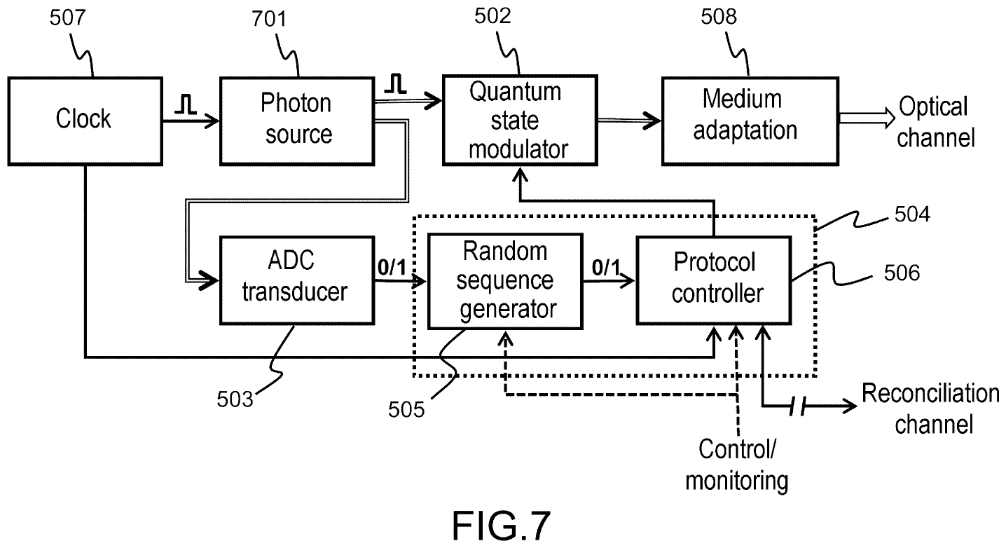

FIG. 7 shows an optical signal generation device according to another embodiment of the invention, in which the photon source 701 is configured to generate two streams of photons, a first stream to the quantum state modulator 502 and a second stream to the ADC transducer 503. Two parallel-mounted pulsed lasers or two single-photon sources are some examples of a two-output photon source.

The optical signal generation device according to the invention limits the number of equipments needed to transmit an optical signal enabling quantum key exchange, using one and the same photon source to implement three functions/equipments: the random number generator, the protocol controller and the photon emitter/modulator. These functions/equipments may thus be integrated into a single equipment. The advantages of such an equipment are:
a reduction in the mass, power consumption and volume of the equipment, related in particular to the integration of the random sequence generator into the same equipment as the protocol controller and the photon emitter,
a reduction in total cost,
an increase in robustness when confronted with electromagnetic radiation analysis attacks on communication links between equipments, since all functions are able to be implemented within one and the same equipment, which may be shielded and secured, thus increasing compatibility with the TEMPEST standards preventing electromagnetic leaks (and therefore risks of cyber-attacks) and environmental interference.

The invention includes a random sequence generator 505, which makes it possible to increase performance in terms of speed (transmission frequency) and entropy (quality of the random) of the random binary string generated by the ADC transducer 503. A quantum key exchange (QKD) link using the invention as a qubit transmitter (Alice) will be more efficient than those from the prior art, and will allow more keys to be exchanged. In addition, the random sequence generator makes it possible to offer very good entropy of the transmitted data, and therefore contributes to a good quality of the quantum keys that are exchanged.

Ultimately, integrating the random sequence generator and the protocol controller into one and the same device also makes it possible to dispense with the connection between these two units, and therefore to further increase the speed of generation of the random.

The invention relates to a device used as a transmitter of random strings of qubits for a quantum key exchange link. The device may consist of separate equipments (clock 507, photon source 501, modulator 502, ADC transducer 503 and computing means 504), but also on a complete device integrating all of these equipments. It may be used for example:
for an optical-fibre quantum key exchange link,
embedded in a satellite, in order to implement a quantum key exchange link between
a satellite (Alice) and an optical ground station (Bob).

Using it for quantum key exchange applications in the space sector offers significant advantages:
simplifying the satellite payload, offering a competitive mass, consumption and volume budget,
reducing development, assembly, integration and testing (AIT) costs for the payload,
reducing electromagnetic leaks that reveal random numbers on various payload signals.

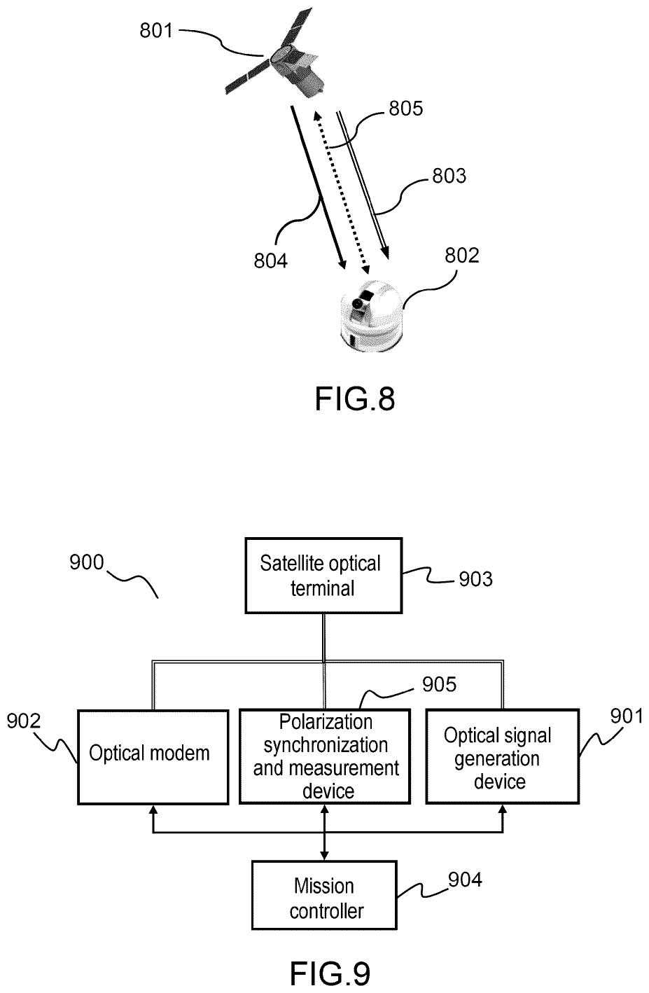

FIG. 8 illustrates the components of a satellite quantum key exchange mission. It contains two stations, a satellite station 801 (Alice) and an optical ground station 802 (Bob), with:
a quantum optical link 803, implemented by carrying on board the satellite an optical signal transmission device according to the invention (qubit transmitter) and an optical terminal (telescope),
a “conventional” optical or RF link 804 for reconciling the data, which requires, on board the satellite, an optical modem and an optical terminal for an optical link, or an RF modem and an antenna for an RF link.
an optical ancillary link 805 enabling:
   synchronization between the qubit transmitter (the optical signal transmission device according to the invention) and the qubit receiver of the station, measurement of polarization distortions caused by free-space propagation and passage through the atmosphere of the optical signal. This measurement makes it possible to act on the media adaptation 508 of the device of the invention.

FIG. 9 illustrates one example of a payload on board a satellite, in the case where the reconciliation link is provided by an optical link. The payload 900 comprises an optical signal generation device 901 according to the invention, an optical modem 902 for transmitting the reconciliation data exchanged between the device 901 and the receiver, both connected to an optical terminal 903, or telescope. The payload also comprises a polarization synchronization and measurement device 905 for synchronizing the qubit receiver of the ground station with the device of the invention and measuring polarization distortions of the optical channel. The payload is supplemented by a mission controller 904 configured to establish, maintain and close (quantum and conventional) links, schedule operations and manage the payload, including the controlling and monitoring of the signal generation device 901.

When the reconciliation channel is a radiofrequency channel, then the modem 902 is an RF modem connected to an antenna.

The satellite quantum key exchange may be implemented in equivalent fashion using the optical ground station as transmitter and the satellite as receiver.

1. A device for generating an optical signal in the form of a succession of optical pulses a quantum state of which codes binary information for quantum key exchange between a transmitter and a receiver, the device comprising, in one and the same equipment:
a photon source configured to generate at least one pulse stream comprising one or more photons,
a quantum state modulator configured to generate said optical signal based on one of the pulse streams generated by said photon source by adjusting the number and quantum state of the one or more photons of the pulses, said number and quantum state of the one or more photons of the pulses being defined by a control word,
the device further comprising, in said equipment:
a device, referred to as ADC transducer, configured to convert the photons of one of the pulse streams generated by said photon source into a random binary string, digital computing means configured to:
generate at least one random sequence having a given probability distribution and rate, based on the random binary sequence produced by said ADC transducer,
generate the control word that is transmitted to said quantum state modulator in accordance with a given key exchange protocol, based on said at least one random sequence.

2. The optical signal generation device according to claim 1, furthermore comprising a device for adapting the optical signal delivered by the quantum state modulator to the transmission medium of said optical signal.

3. The optical signal generation device according to claim 2, wherein the transmission medium of the optical signal is chosen from among an optical fibre and free space.

4. The optical signal generation device according to claim 1, wherein the photon source is one of:
a pulsed laser configured to generate an optical pulse stream, associated with a power divider configured to generate at least two pulse streams from said pulse stream of the pulsed laser,
a pulsed laser configured to generate two pulse streams,
a single-photon source configured to generate a stream of pulses each comprising a photon, associated with a splitter plate configured to divide said pulse stream into at least two distinct pulse streams, or
a single-photon source configured to generate two streams of single photons.

5. The optical signal generation device according to claim 1, wherein the ADC transducer is configured to exploit a random quantum phenomenon of the photons of one of the pulse streams generated by the photon source to determine said random binary string.

6. The optical signal generation device according to claim 5, wherein said random quantum phenomenon exploited by the ADC transducer is chosen from among:
an initial phase of the pulses,
an amplitude of the pulses,
a time of occurrence of the pulses,
a speckle pattern of the pulses.

7. The optical signal generation device according to claim 1, wherein said at least one random sequence generated by the computing means is obtained by applying one-way mathematical functions to the random binary string produced by the ADC transducer.

8. The optical signal generation device according to claim 1, wherein the digital computing means are furthermore configured to implement a reconciliation process on the data transmitted to the receiver.

9. A payload for a satellite configured to carry out a quantum key exchange mission with a ground station, the payload comprises:
an optical signal generation device according to claim 1,
an optical terminal connected to an output of the optical signal generation device,
an optical modem connected to said optical terminal or a radiofrequency modem connected to a radio antenna,
a mission controller configured to supervise the scheduling of the quantum key exchange operations, and
a polarization synchronization and measurement device configured to ensure synchronization between the optical signal generation device and the ground station, and to measure distortions experienced by the optical signal between the optical signal generation device and the ground station.
